(19) United States
(12) Patent Application Publication
(10) Pub. No.: US 2025/0066872 A1
(43) Pub. Date: Feb. 27, 2025

(54) HEAPS FOR HEAP LEACHING

(71) Applicants: ANGLO AMERICAN TECHNICAL & SUSTAINABILITY SERVICES LTD, London (GB); ANGLO CORPORATE SERVICES SOUTH AFRICA (PTY) LTD, Rosebank (ZA)

(72) Inventors: Anthony Owen FILMER, Brisbane (AU); Christopher Alan BILEY, London (GB); Luke Mark KEENEY, Brisbane (AU)

(21) Appl. No.: 18/704,566

(22) PCT Filed: Oct. 26, 2022
(86) PCT No.: PCT/IB2022/060267

§ 371 Date: Apr. 25, 2024

Related U.S. Application Data
(60) Provisional application No. 63/271,980, filed on Oct. 26, 2021.

(51) Int. Cl. C22B 3/14; C22B 1/16; C22B 1/24; C22B 3/00; C22B 11/00; C22B 11/08; C22B 15/00

(52) U.S. Cl. CPC C22B 3/14; C22B 1/16; C22B 1/24; C22B 11/04; C22B 11/08; C22B 15/0065; C22B 23/0446

(57) ABSTRACT

THIS invention relates to a method and heap for recovering metal values from ore in a heap leach process. The method includes the steps of depositing and stacking crushed ore 16 on an impermeable pad 12 to form a heap, and enclosing the heap with a substantially impermeable coating 18 to both gas and liquid; to form a sealed heap. The sealed heap is irrigated with a leachant added inside the top of the heap, allowing the leachant to percolate through the heap and removing leachant at the base of the heap, either for recirculation or subsequent processing. Oxygen containing gas is added to the base of the sealed heap.

### BACKGROUND OF THE INVENTION

Heap leaching is low-cost alternative to flotation and is commonly used to recover values from oxidised and secondary copper ores, gold and uranium. Despite the opportunity of directly producing metal, and the lower cost of comminution, the use of heap leaching is mostly limited to low grade ores due to low recovery of values in heap leaching.

Ores for heap leaching are crushed, typically with upper size limits varying from around 10 mm to 500 mm, depending on the application. For finer crushing, the ore is agglomerated to reduce the impact of fines which might otherwise block the heap.

The crushed ore is stacked in heaps, and leachant is trickled through the heaps to dissolve the values. The heap operates in an unsaturated state, allowing air to be introduced to the heap as an oxidant. Pregnant liquor is recovered from the base of the heap and processed to recover the metal of interest.

Heaps are sometimes covered when utilised in heap leaching. This covering can either minimise dilution of the leachant caused by rainfall on the heap; or be used to insulate the heap to partially retain heat. The effectiveness of this covering is limited by the need for the air, used to oxidise the contained minerals, to enter the base and exit the sides and top of the heap.

The upper surfaces of the heap, open or covered, are exposed to atmosphere, and hence volatile reagents such as ammonia or chlorine cannot be used in heap leaching. See: Ammoniacal Percolation Leaching of Copper Ores, J. E. Dutrizac, Published 1 Jul. 1981, Materials Science, Chemistry, Canadian Metallurgical Quarterly https://www.semanticscholar.org/paper/ Ammoniacal-Percolation-Leaching-of-Copper-Ores-Dutrizac/68114e3749397eb6cfc437c18d37f0e8fe7f02d9 Furthermore, the open or covered heap also eliminates the opportunity to enrich the oxygen content of the air within the heap, in cases where O2 availability is a determining factor in leaching rate.

In effect, the use of common leaching reagents like ammonia, or chlorine, or oxygen, in heap leaching is eliminated by this inability to retain the volatiles in the heap.

For this reason, non-volatile acidic conditions are typically used for leaching copper, uranium and nickel containing ores, while non-volatile basic cyanide leachant is used for recovery of gold.

For ores with gangue components that react with the acidic leachant during leaching, this limited choice of different leachants is problematic. For example, some copper ores and nickel ores contain significant soluble oxide species such as carbonates, and even biotite, and hence consume excessive acid. Whilst a basic leachant like ammonia would overcome the gangue reactivity issue, excessive ammonia losses which would occur in the heap leach.

Similarly, it is not possible to sequentially heap leach ores containing both copper and gold, initially an acidic leach for copper, then a strongly basic cyanide leach for gold. The initial acid leach to recover copper creates an acidic heap which is inherently hazardous for subsequent cyanidation in the same heap.

Where the ore to be heap leached contains significant sulphide concentration requiring oxidation, the oxygen in the air is utilised as the oxidant. Air is blown through the heap to replace the oxygen which is depleted by reaction. This air is warmed and humidified by the exothermic oxidation reactions taking place in the heap and exits the surfaces of the heap carrying with it the heat from this reaction.

Various methods have been proposed to retain the heat generated by the bio-oxidation of sulphides in the heap, usually by balancing the countercurrent flows of air up through the heap and leachant down the heap. The heat exchange between the fluids entering and exiting the heap is such that the oxygen depleted air leaving the heap does not carry as much heat. (Crundwell WO 2004/027099 A1, and Miller WO 00/71763 A1). However, no large scale operation using such techniques has been achieved at temperatures hot enough for the bio-oxidation of chalcopyrite. Despite the sulphide oxidation reactions being significantly exothermic, the temperature in the prototype heaps trialing this heat balance method have typically averaged around 40° C. Ores containing intractable minerals such as chalcopyrite cannot be heap leached efficiently at such temperatures, even with the extended residence times available in heap leach.

The open nature of heap leaching also nullifies the use of even more elevated temperatures such as could be achieved by injection of steam into the heap.

Despite the limited range of suitable ores, and suitable heap leaching reagents, the costs of heap leaching are inherently low because fine grinding of the ore for heap leaching is not required; and the ore does not need to be suspended in a capital-intensive reactor during the leaching process. The main downside of heap leaching is the low extraction that is achieved, even in inherently suitable ores.

This low extraction in heap leaching is caused by various constraints on conventional heap leaching
The first constraint is minimum crush size, due to low heap permeability caused by excessive proportions of fines, and hence less than ideal surface exposure of the minerals to be leached
A second constraint is the slow oxidation reactions of some valuable minerals such as chalcopyrite, especially in heaps operating at near ambient temperatures.
A third constraint is the acid consumption and resultant pH profile through the heap, particularly when significant fractions of gangue reacts with the acidic leachant.
A fourth constraint is the inability to utilise volatile leachants such as ammonia, or enriched oxygen as an oxidant, due to the reagent losses from the surfaces of the heap.

Alternative leaching methods can overcome some of the problems associated with heap leaching, but in so doing create other constraints to their widespread application in leaching of sulphidic and metallic ores.

Agitation leaching can extract a higher proportion of the values from the ore, due largely to the energy intensive fine grinding of the ore required to suspend the ore in the leachant. The reactors are capital and energy intensive and as such require short reaction rates. They require solid liquid separation to recover the pregnant liquor from the residue.

Autoclaves can extract a higher proportion of the values from the ore. They typically operate at temperatures exceeding 100° C. and with an over-pressure of oxygen. Residence times are typically measured in minutes. The capital intensity is such that such autoclaves are usually used only for leaching concentrates.

In vat leaching, the ore is immersed in a slurry without agitation, enabling longer residence time. Once soak time is sufficient the liquid is drained for metal recovery. Vat leaching is unsuited for sulphide oxidation due to poor distribution of air.

For all these reasons, hydrometallurgy has remained a technique for recovery of values that has been limited in application to those ores which offer a higher recovery by leaching than flotation. Flotation has dominated metal recovery, while heap leaching has been confined to low grade ores or those ores unsuited to flotation.

It is an object of the present invention to provide a heap leach reactor and a heap leaching method to address these constraints to heap leaching.

### SUMMARY OF THE INVENTION

According to a first aspect of the invention there is provided a method of recovering metal values from ore in a heap leach process, including the following steps:
depositing and stacking crushed ore on an impermeable pad to form a heap, and enclosing the heap with a substantially impermeable coating to both gas and liquid; to form a sealed heap;
irrigating the sealed heap with a leachant added inside the top of the heap, allowing the leachant to percolate through the heap and removing leachant at the base of the heap, either for recirculation or subsequent processing; and
adding an oxygen containing gas to the sealed heap.

By “sealed” is meant a heap fully enclosed with a liquid and gas impermeable layer, with specific sealed entry and exit points for reagents to be added or removed from the sealed heap.

Preferably, gas pressure within the heap is maintained at between 0.5 and 2 atmospheres and preferably between 0.8 and 1.2 atmospheres and even more preferably around 1 atmosphere.

Preferably, the temperature within the heap is elevated by the oxidation of the contained sulphide, preferably operating within the range from ambient temperature to 100° C., and even more preferably between 50 and 80° C.

The temperature within the heap may be controlled by external heat exchange to set the temperature of the leachant being irrigated inside the sealed heap.

The temperature within the heap may be controlled by the amount of air added together with the oxygen, and with subsequent purging of warm gas.

The sealed heap may be utilised to contain a volatile leaching reagent such as ammonia or cyanide or chlorine or oxygen.

The sealed heap may be utilised to leach sulphide ores containing one or more of the valuable metals of copper, gold, nickel, uranium and zinc.

The sealed heap may be utilised to leach sulphide concentrates that have been mixed with the ore, and contain one or more of iron and the valuable metals of copper, gold, nickel, uranium and zinc.

The sealed heap may be utilised to sequentially leach ores in acid (e.g. pH 1.0 to 3.5) and then basic conditions (e.g. pH 8.5 to 11.5) or vice versa, to recover different valuable components from the ore.

The ore to be leached may be crushed and then fully or partially agglomerated prior to stacking.

The sealed heap may be utilised to leach primary copper ores containing chalcopyrite at temperatures between 40-90° C. and preferably between 60-80° C. and even more preferably around 70° C.

The sealed heap may utilised to leach ores containing high levels of acid consuming gangue (i.e. containing carbonates such as calcite, or magnesium and calcium rich silicates) by operating under basic conditions (e.g. pH 8.5 to 11.5).

The sealed heap may be utilised to enable stacking, agglomeration or desliming, and leaching of ores crushed to less than 10 mm, and preferably less than 5 mm and even more preferably less than 3 mm.

Typically, the sealed heap has a height of between 5 and 50 m, and preferably between 20-30 m.

The sealed heap may be utilised to store residue at the completion of the heap leach.

The sealed heap may be utilised to efficiently heat the ore to be leached using external heating.

The sealed heap may be utilised to leach ultramafic ores which the structure and the heap leach residue is utilised for subsequent sequestration of carbon dioxide.

The sealed heap may be utilised to leach ores under climatic conditions in which it is difficult to maintain a water balance with the rainfall or evaporation that occurs with an open heap.

The sealed heap may be dynamic in nature, and utilise a fixed structure to contain the crushed ore, which is then removed from the structure when it has been leached, and replaced with another batch of ore

The method may include multiple sealed heaps, with each heap comprising multiple cells.

Reagents may be transferred between cells within a heap or heaps to control leaching conditions, and to minimise the reagent losses in the leach residue.

Leachant may be transferred between the cells to transfer heat between cells.

Leachant may be transferred between cells as part of a washing procedure to recover reagent from a leached residue, whilst minimising water usage.

The gas may be transferred between cells to control the oxygen content of the heap and optimise the efficient use of oxygen.

The leachant may be transferred both within and between cells to vary the irrigation rate of the heap, according to its extent of leaching.

The sealed heap may be further insulated with a layer of sand on top of the impermeable coating

Flotation concentrate may be mixed with the crushed rock and leached in the sealed heap to provide both additional heat and dissolve the contained values.

Typically, the leachant irrigation rate is adjusted according to the extent of leaching to rapidly recover values early in the leaching cycle, and then increase the tenor of the pregnant liquor late in the cycle.

The ore to be leached may be ultramafic nickel ore and the leachant is ammonia, typically containing 1M to 4M ammonia.

The oxygen containing gas may be air, or a gas containing greater than 20% oxygen and up to 100% oxygen.

According to another aspect of the invention, there is provided a heap for recovering metal values from ore in a heap leach process, comprising:
crushed ore stacked on an impermeable pad to form a heap with a bottom and a top;
a substantially impermeable coating enclosing the heap;
an irrigation system for irrigating leachant at the top of the crushed ore heap;
a sump for removing leachant at the base of the heap; and
means for adding an oxygen enriched gas to the sealed heap.

The ore typically contains one or more of the valuable metals of copper, gold, nickel, uranium and zinc

The crushed ore may include sulphide concentrates that have been mixed with the ore, and contain one or more of iron and the valuable metals of copper, gold, nickel, uranium and zinc

The ore is crushed ore that may at least be partially agglomerated prior to stacking.

Typically, the ore is crushed to less than 10 mm, and preferably less than 5 mm and even more preferably less than 3 mm.

The heap may have a height of between 5 and 50 m, and preferably between 20 and 30 m.

The heap may be dynamic in nature and utilise a fixed structure to contain the crushed ore, which is then removed from the structure when it has been leached and is replaced in the reactor with another batch of ore.

The invention also relates to a structure comprising multiple sealed heaps as described above, with each heap comprising a cell.

Preferably, the structure includes means for transferring reagents between cells to control leaching conditions.

Preferably, the structure includes means for transferring leachant between the cells to transfer heat between cells.

Preferably, the structure includes means for transferring gas between cells to control the oxygen content of the heap and optimise the efficient use of oxygen.

Preferably the heap or cells is/are further insulated with a layer of sand on top of the impermeable coating.

### BRIEF DESCRIPTION OF THE DRAWING

FIG. 1 is a schematic representation of a sealed heap leach structure, according to an embodiment of the invention;

FIG. 2 illustrates the column acidic bioleaching of a primary copper ore, using deslimed ore of 6.7 mm and 2.4 mm top sizes, at temperature of 70° C.;

FIG. 3 illustrates the initial column acidic bioleaching of another primary copper gold ore with deslimed ore of 6.7 mm and 2.4 mm top sizes, at a temperature to liberate gold for subsequent cyanidation;

FIG. 4 illustrates the extractions achievable from a ground Canadian ultramafic nickel ore ground to <75 microns, and leached in 4M NH3 in gently agitated flasks;

FIG. 5 illustrates the initial stages of copper extraction in a column leach of a Platreef ore using 4M NH3 at 60° C. to liberate the PGMs for subsequent cyanide leaching; and

FIG. 6 illustrates the extraction of copper from <106 micron Platreef in a rolling bottle containing ammonia, prior to leaching the residue in cyanide for PGM extraction.

### DESCRIPTION OF PREFERRED EMBODIMENTS

THIS invention relates to a heap leach reactor and a heap leaching method that extends the application of hydrometallurgy, in which most and preferably all of the following are addressed:
Agitation of the solids is not required, providing the opportunity to utilise a higher crush size at which the recovery is optimised relative to crushing costs.
Heat is generated by the sulphide oxidation and used to maintain an elevated temperature within the sealed heap reactor, to accelerate the leaching rates and enable application to the more intractable mineral species without excessive external heating.
Residence times can be extended such that the leaching can recover both the mineral values on the surface of the particles and also those found within micropores in the rock matrix.
The reactor is sealed such that full range of possible leachants can be utilised without concerns about volatile losses and making the leaching system applicable to a wide range of acidic and basic ore types without excessive reagent consumptions.
And where the leaching conditions can be controlled uniformly throughout the reactor, and the reactor size is scalable to accommodate a wide range of leaching rates.

With this combination of attributes of reactor and method it will be possible to combine the benefits of low-cost heap leaching with many of the conditions which currently are confined to agitation leaching; and hence extend the application of hydrometallurgical recovery across all grades of ore and concentrates, and across a wider range of ore types.

The invention covers both a heap leach reactor and a heap leaching method which:
utilises one or more cells of crushed and stacked rock,
that is sealed in a heap by an impermeable coating,
within which leachant can be added to the top of the heap and removed through the base for either recirculation within the heaps or for subsequent processing
and into which oxygen enriched gas can be introduced to replenish the oxygen consumed by the reactions within the heap.

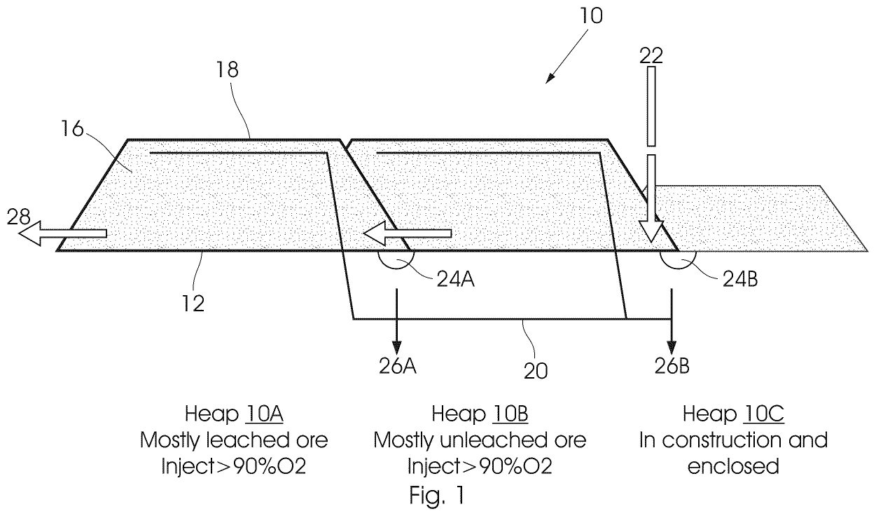

Such a reactor is illustrated schematically in FIG. 1 and termed a “sealed heaps” shown generally by the numeral 10. As illustrated, the sealed heaps have two active heaps/cells 10A and 10B. The sealed heaps 10 are constructed on an impermeable pad 12 and comprises heap cells 10A and 10B, with a new heap cell 10C which in this embodiment is under construction, constructed from crushed rock 16. The heap cells 10A and 10B are sealed with a substantially impermeable enclosure 18 which encloses each cell within the entire heap, and is insulated if necessary for heat retention within the heap cell. The enclosure 18 may comprise welded geotextile, or shotcrete, or bitumen, or any other material that can create an impermeable barrier. A circulation system 20 made from insulated piping is provided for circulating and irrigating leachant inside the top of the heap cells 10A and 10B, with minimal heat loss to the surrounding environment. The leachate collected in the sump may be circulated between cells to adjust temperatures and acidity/basicity as may be required. The water balance within each cell is maintained through the addition of processed PLS (pregnant leach solution) and acid and water as required. Air or oxygen enriched gas 22 is added at the base of the heap 10B using a pump and sealed connecting pipe which penetrates the seal on both heaps 10A and 10B. Sumps 24A and 24B are provided for draining pregnant leach solution (PLS) 26A and 26B from the bases of the heap cells 10A and 10B, respectively. The oxygen added to one cell may transfer between cells through pipes connecting the cells. A purge valve 28 is provided to intermittently flush air from a newly sealed heap cell.

The sealed heaps leach 10 operate in an unsaturated mode, just as for conventional heap leaching, allowing for both liquid and gas distribution through all parts of the sealed heap.

The impermeable enclosure 18 around the heaps 10 enables the limited and controlled ingress and egress of gas and liquid to and from the sealed heaps 10. Without direct contact between the ore and atmosphere, the transfer of gas to the surrounding atmosphere is limited, consequently reducing heat loss from the heaps 10. As thermal insulation of the sealed heaps 10 can be utilised, retaining most of the heat of reaction within the heap 10 becomes possible. Thus, the exothermic reactions within the heaps 10 can be utilised both internally within a cell and by transfer of heat between cells, and hence to heat the contents of the heaps 10. Heat within the heaps 10 can be controlled, by heat exchange with the circulating leachant 20 to transfer heat into or out of a heap cell, or by increasing the percentage of air in the gas 22 injected into a heap cell, and consequently increasing the bleed rate from the heap cell.

The impermeable coating 18 also enables the use of volatile and/or potentially hazardous chemicals as leachants by retaining them within the sealed heaps 10. An example is the use of ammonia as a leachant for metals such as copper and nickel. A second example is the use of basic cyanide for gold or PGM dissolution after pre-oxidation in acid or basic conditions.

The pressure within the heaps 10 is maintained around ambient pressure, thus enhancing the effective sealing of the heaps 10. As the pressure differential with the external environment is modest any unintended leaks in the enclosure do not lose either significant quantities of reagents or heat.

The sealed heaps 10 may be fixed in location where the crushed rock is leached and remains permanently within the enclosure, or dynamic in nature where the rock is stacked in a permanent location, sealed and leached, then reclaimed and moved to another site for disposal.

The selection of fixed or dynamic leach design will be resource specific, depending on leaching rate, available land suitable for siting a heap, and the required operational conditions. If the heap is dynamic in nature, a purpose-built reactor design will be more utilised to house the crushed rock, whereas for a fixed heap the enclosure will be based around the natural shape of the stacked heap.

For example, if a slightly elevated pressure is required to sustain optimum reaction conditions near 100° C., the crushed rock can be stacked in a purpose-built walled enclosure, which is subsequently sealed. At the completion of the heap leach, the enclosure can be opened, and the stacked ore removed, much as occurs in a conventional dynamic heap leach.

In another example, if the required leaching duration is relatively short, such as less than 50 days, a purpose-built walled enclosure with a fixed method of stacking and reclamation of crushed rock and of fluids distribution may be appropriate for the sealed heap leach.

Whether fixed or dynamic, the leachant can be added to the top of the heap and collected in a sump located at the lowest point within the heap structure. This enables recirculation of the leachant to wash the dissolved solids to the sump 24 at the base, and the use of a bleed stream to progress the pregnant liquor to subsequent processing. As such, the irrigation system 20 can be used during both the leaching and washing stages of the heap leach.

The ability to recirculate the leachant within the sealed heaps 10 has specific benefits in those applications where indirect oxidation occurs in leaching, enabling a high surface area for exposure of the liquid to re-oxidation of the leachant as it flows down through the oxygen filled heap. Examples of such systems are acidic ferric leachants such as those that are used in bio-leaching, or acidic copper chloride, or copper ammonia solutions.

The recirculation also assists with heat transfer within the sealed heap cells.

In one embodiment, oxygen may be injected to the heaps 10, to maintain the desired partial pressure of oxygen by recirculating the gas within the heap, and hence reducing without the need to vent gas. The purification of oxygen from air is a well-known commercial process, with the oxygen content in the product typically greater than around 90%. The cost of purified oxygen is quite acceptable as an oxidant for sulphide ores providing it is efficiently utilised. The sealed heap enables highly efficient oxygen utilization, and the pressure differential within the heap that arises as the oxygen is consumed, contributes to efficient distribution of oxygen throughout the heap.

As some air will always be present in the heaps 10, arising from impurities in the enriched oxygen source, or from the original air present in the voidage of the heap, or leaks in the system, a modest bleed stream is required from the heap to allow nitrogen and other gasses to escape. The bleed stream from one cell can be used to displace lower grade air from subsequent cells within the overall heap. Alternatively, the bleed stream can be recirculated as a feed to the further purification of the oxygen source.

The controlled bleed stream can be scrubbed of any volatile leaching components prior to being disposed to the atmosphere.

The use of oxygen injection, particularly in the embodiment in which much of the air present within the sealed heap has been displaced, avoids depletion of the oxidant concentration during heap leaching. Due to relatively rapid gaseous diffusion, the oxygen concentration remains relatively uniform throughout the heap, both at the macro and micro porosity levels.

Such oxygen can be purified via a number of commercially available means, preferably to greater than 90% purity and even more preferably to greater than 95% purity.

Irrigation rates can be adjusted by altering pumping velocities from the sump, and hence liquid flow rate through the heaps 10. This enables either continuous or intermittent flows, depending on the optimum requirements of the leaching system. Liquid migrating down through the heap carries the dissolved metals for ultimate recovery. At the end of the leach or of one part of a sequential leach, the heap can be washed using the same irrigation system.

The quantity and grade of the pregnant liquor proceeding to further processing may be adjusted as required, with a resultant increase or decrease in the proportion of leachant which is recirculated.

The sealed heaps 10 can be over-stacked, with the base of the next heap being the top of the previous heap.

In summary the current invention combines the advantages of heap leaching, low comminution and material handling costs and large surface area for gas/liquid contact; with the advantages of agitation leaching, ability to operate at elevated temperature whilst containing the reactants and ore within a controlled environment.

### Examples of Possible Applications Enabled by the Sealed Heap

The sealed heap that represents this invention can be utilised with ore types that are inherently suited for conventional heap leaching. Examples would be the leaching of a secondary sulphide or gold ore.

However, the system has specific advantages where conventional heap leaching can be problematic, due to either inherently slow reaction rates, or where the use of a volatile leaching reagent can significantly enhance extractions or reduce heap leaching costs.

Some examples, highlighting the benefits over conventional heap leach, are provided.

Primary copper ores, particularly those containing significant chalcopyrite, are difficult to heap leach due to the inherently slow leaching rate of the copper containing minerals. Through use of the sealed heap, potentially in combination with oxygen enrichment, heat can be retained in the heap thus raising the temperature well above the 60° C. required to achieve accelerated bioleaching of chalcopyrite. The leachant can be circulated within the sealed heap thus retaining heat and building up the concentration in the pregnant liquor.

Furthermore, for those copper ores also containing significant byproduct or coproduct gold, the residue from the previously described sealed heap leach can be washed to remove any remaining soluble species that would consume cyanide. The gold has been exposed through the preceding acidic heap leach and hence is readily recovered with cyanide. The sealed heap means that even if HCN generation occurred in any zones that are not fully neutralised by washing of the acid leach residue, it would not escape into the environment.

And for mines which have part, or all of their ore processed by flotation, the flotation concentrate, or a fraction thereof can be mixed with the crushed rock to be leached in the sealed heap, hence converting the concentrate into a soluble species for subsequent recovery. The flotation concentrate to be added, may be at a grade which is saleable thus replacing the conventional smelting process, or may be a scavenger concentrate, designed to improve recovery of sulphides from a stream that would otherwise be assigned to flotation tailings.

Some copper ores contain excessive acid consuming gangue. Such ores, and indeed any copper or nickel ores, can be heap leached with ammonia as the leachant because the ammonia is contained within the sealed heap. The temperature rise will be more constrained than that of acid leaching, as the pyrite content leaches only slowly in ammonia. However, the temperature rise is still considerable and ammonia as a strong complexant for copper and nickel, enables the sealed heap leaching of chalcopyrite and nickel sulphides at acceptable rates.

Volatile reagents such as ammonia, having a high vapour pressure, will equilibrate in concentration through the gas transfer within the heap. Thus, the reagent concentration profile of both oxygen and ammonia through the heap profile is uniform, unlike acid which must either be added to the top of the heap. This equilibration enables consistent leaching kinetics throughout the full depth of the heap.

Where gold or PGM co-products are present in the ore, ammonia leaching can be followed by cyanidation or chlorination to recover the precious metals. This is particularly relevant to the nickel deposits where PGMs can form a high proportion of the total metal value, but dissolve too slowly for consideration of agitation leaching.

Where values are finely disseminated in an ore, finer crushing is necessary to expose a large proportion of the values. This occurs with many nickel ores, where the conventional heap leach recovery is significantly reduced due to the minimum crush size required to maintain heap permeability required to achieve high irrigation rates. Using the current invention, particularly when using ammonia as the leachant, irrigation rates can be reduced due to effective mass transfer of reagents. Thus, crush sizes prior to agglomeration can be reduced from the conventional minimum of around 10 mm, to less than 5 mm and even less than 1 mm.

The finely crushed ore can also be agglomerated or pelletised to improve heap permeability.

### EXAMPLES OF THE INVENTION

Various leaching experiments have been carried out in columns and agitated vessels, to illustrate the benefits of the sealed heaps: reagent flexibility, heat retention and lower crush size.

### Example 1

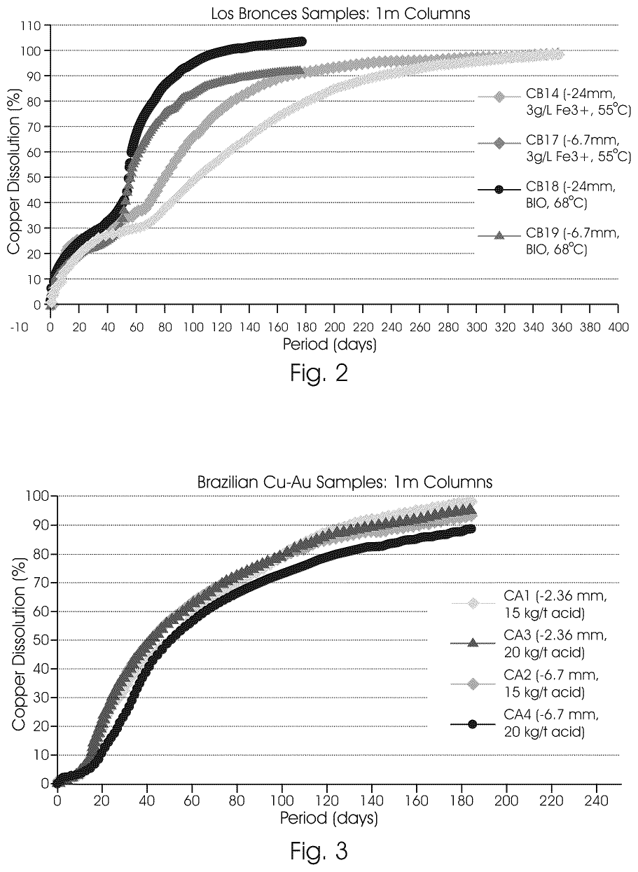

In the first example of the benefits of the sealed heap, the results of 1 m column leaching of a sample of a Chilean primary copper ore are illustrated. The positive effect of temperature (70° C.) and particle size (2 and 6 mm) on leach extractions are illustrated in FIG. 2.

### Example 2

In a second example, a Brazilian primary copper ore containing significant gold is leached in 1 m columns under conditions simulating a 70° C. bioleach. With reference to FIG. 3, the extraction of copper benefited from temperature and particle size (2 and 6 mm), and in all cases was around 90% or higher.

The residue from the column leach was then removed and washed to remove residual soluble copper, and then leached in a rolling bottle containing excess cyanide for 24 hours. Gold extractions were around 95%, reflecting the gold liberation caused by prior bioleaching of the copper and iron sulphides.

### Example 3

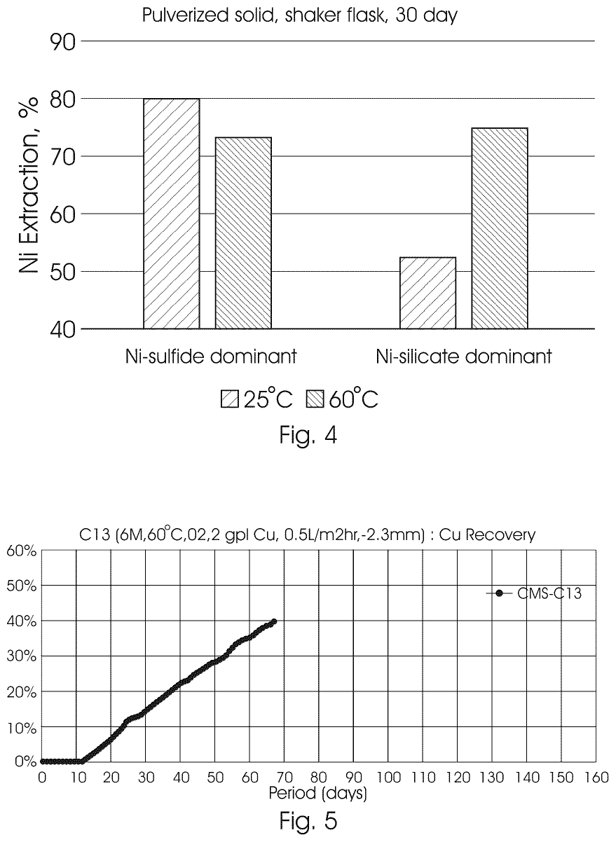

In the next example, two different Canadian nickel ultramafic ores were ground to <106 micron and leached in 4M ammonia. With reference to FIG. 4, the nickel extraction at the elevated temperatures illustrated the potential to leach the ore in an ammonia based sealed heap leach system, made possible by a sealed heap.

### Example 4

A PGM containing ore from the Platreef seam in South Africa being column leached in ammonia at 60° C. The extraction of nickel is steadily increasing as illustrated in FIG. 5 showing the effectiveness of ammonia as a leachant.

### Example 5

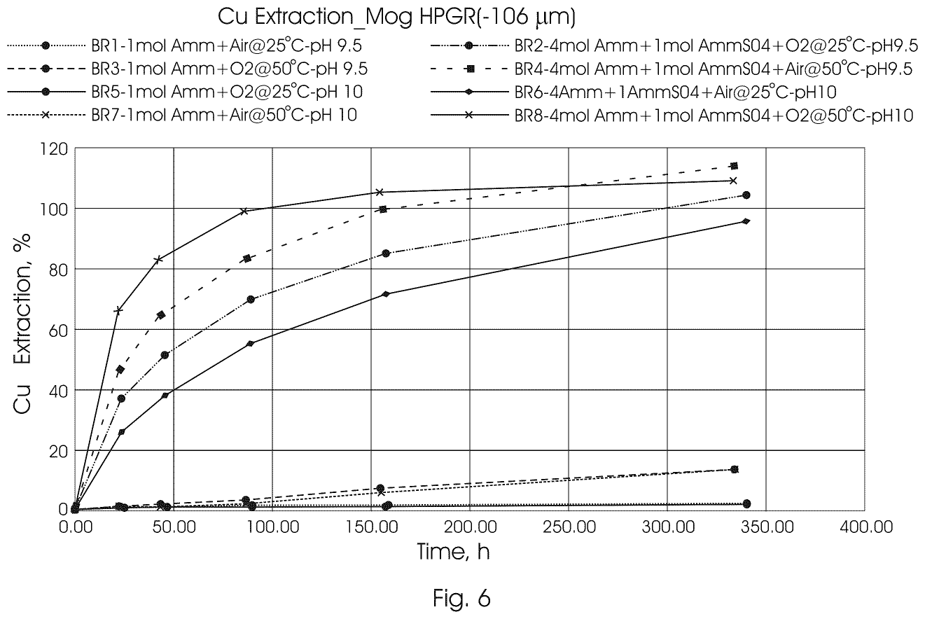

A rolling bottle test on the same ore sample ground to <106 microns, clearly illustrated in FIG. 6 the need to utilise high ammonia concentrations to achieve high copper extractions. The residue from these rolling bottle tests were leached 5 days for in excess cyanide to extract the PGMs. Overall gold and palladium extractions from the combined leaching were around 75%, with platinum extractions around 35%.

### Supplemental Benefits of the Sealed Heap Design

In addition to heat retention and containing volatile reagents the sealed heap opens up additional benefits which enable faster, more complete, and lower cost recover of values.

The first supplementary benefit is the potential for higher and more consistent oxygen concentration within the sealed heap. The higher oxygen content allows for more rapid oxidation within the heap, without concern about heat loss at higher gas flow rates required to flow out the oxygen depleted gas. In addition, the reduced nitrogen content in the gas eliminates the dead zones within the heap, or at the micro-level within cracks in rock particles. This enriched oxygen can also be provided selectively at times when heat generation or retention is essential, or when the reaction rate is constrained by O2 availability.

The second supplementary benefit is the ability to vary irrigation rate, to ensure effective provision of the leaching reagents to the ore. Normally, parts of a heap are almost saturated and other parts almost denuded of water, causing substantive differences in gas flow rates in individual locations within the heap. The use of recirculating leachant within the sealed heap enables irrigation rate to be varied to achieve effective wetting without concern for heat loss.

The ability to recirculate leachant within the heap or between cells in the heap also facilitates heat transfer within the heap. For example, heat transfer can be enhanced by varying the irrigation rate in the whole or specific parts of the heap.

The irrigation rate can also be used to adjust the leaching conditions to suit the extent of leaching that the ore has undergone. At the commencement of the leach, reactions are rapid due to the high exposed surface area of the sulphides. A faster irrigation rate allows the more rapid recovery of values in the pregnant liquor. Later in the leach cycle, the dissolution of values slows as reactions become limited by diffusion through micro-pores in the rock particles. The irrigation rate can be adjusted accordingly, to maintain a high PLS concentration whilst not consuming excessive leachants. Ultimately, intermittent irrigation can be applied to recover values from almost exhausted heaps.

A third supplementary benefit is the ability to design heaps of different dimensions. The elimination of the constraint relating to the reagent profile through the height of the heap implies the height of the heap is no longer constrained. With removal of most of the fines, either by classification or agglomeration, the height of the heap can be increased. This has several beneficial effects. The surface area to volume ratio of a sealed heap is decreased, thus reducing heat loss. The ratio also reduces the cost of enclosing the heap and the laying of irrigation and aeration piping.

A fourth supplemental benefit is the independence of the conditions in the sealed heap from the influence of climatic conditions.

Sealing the heap enables full control of water balance as rainfall does not enter the heap, allowing heap leaching operation in high rainfall regions. This enables sealed heap leaching in tropical environments, where heavy rainfall events disrupt the conventional heap leaching.

Similarly, a sealed heap enables operation with much lower water consumption than conventional flotation and residue storage as tailings, and lower consumption than conventional heap leach. Evaporation of the leachant does not occur in the irrigation of the sealed heap, even in the most hot, dry and windy conditions. Hence water conservation is improved.

And snow and similar extreme cold are similarly sealed from adversely affecting the heap temperature and hence leaching rate inside the surface of a sealed heap, or of the temperature drop due to cold air and leachant which is pumped through a conventional heap.

A fifth supplementary benefit is the establishment of a heap suited for subsequent sequestration of carbon dioxide. As an example, nickel containing ultramafic rocks can sequester carbon dioxide. The residue from heap leaching is in a porous form in a sealed heap. A flow of enriched CO2 can be absorbed in the sealed heap and converted to a stable carbonate, without concerns over CO2 escape from the surface of the heap.

A sixth supplemental benefit occurs for those ores in which the oxidation of the contained sulphides is insufficient to heat the heap to the desired temperature or requires supplementary heat to initiate the reaction. External heating can be selectively introduced through the leachant or gas flows. The insulation provided by the sealed heap design reduces the amount of external heating that is required to achieve the desired heap temperature.

A seventh supplemental benefit is the enclosure of the leach residue. Where potentially toxic or environmentally detrimental residues exist during or at the completion of the leach, the sealed heap can avoid exposure both during the leaching, and when the residue is converted into permanent sealed disposal site. Examples where this might be applicable is in cyanide heap leaching of gold, or the oxidation of ores or concentrates containing significant arsenic, or with any acid mine drainage arising from residue storage.

In summary, the current invention extends the range of ore types that are suitable for heap leach, accelerates the rate of leaching, enables higher leach recoveries, and achieves these objectives at costs which are comparable to conventional heap leaching.

1. A method of recovering metal values from ore in a heap leach process, including the following steps:
depositing and stacking crushed ore on an impermeable pad to form a heap, and enclosing the heap with a substantially impermeable coating to both gas and liquid, to form a sealed heap;
irrigating the sealed heap with a leachant added inside the top of the heap, allowing the leachant to percolate through the heap and removing leachant at the base of the heap, either for recirculation or subsequent processing; and
adding an oxygen containing gas to the sealed heap.

2. The method claimed in claim 1, wherein the gas pressure within the heap is maintained at between 0.5 and 2 atmospheres.

3. The method claimed in claim 2, wherein the gas pressure within the heap is maintained at between 0.8 and 1.2 atmospheres.

4. The method claimed in claim 3, wherein the gas pressure within the heap is maintained at around 1 atmosphere.

5. The method claimed in claim 1, wherein the temperature within the heap is elevated by the oxidation of a contained sulphide, operating within the range from ambient temperature to 100° C.

6. The method claimed in claim 5, wherein the temperature within the heap is between 50 and 80° C.

7. The method claimed in claim 1, wherein the temperature within the heap is controlled by external heat exchange to set the temperature of the leachant being irrigated in the sealed heap.

8. The method claimed in claim 1, wherein the temperature within the heap is controlled by the amount of air added together with the oxygen, and with subsequent purging of warm gas.

9. The method claimed in claim 1, wherein the leaching reagent includes or comprises a volatile leaching reagent.

10. The method claimed in claim 9, wherein the volatile reagent is ammonia, cyanide, chlorine and/or oxygen.

11. The method claimed in claim 1, wherein ore is a sulphide ore containing one or more of the valuable metals of copper, gold, nickel, uranium and zinc.

12. The method claimed in claim 1, wherein sulphide concentrates have been mixed with the ore, and contain one or more of iron and the valuable metals of copper, gold, nickel, uranium and zinc.

13. The method claimed in claim 1. the sealed heap is utilised to sequentially leach ores in acid and then basic conditions or vice versa to recover different valuable components from the ore.

14. The method claimed in claim 1, wherein the ore is crushed and then fully or partially agglomerated prior to stacking.

15. The method claimed in claim 1, wherein the sealed heap is utilised to leach primary copper ores containing chalcopyrite at temperatures between 40-90° C.

16. The method claimed in claim 15, wherein the temperatures are between 60-80° C.

17. The method claimed in claim 16, wherein the temperature is around 70° C.

18. The method claimed in claim 1, wherein the ore contains high levels of acid consuming gangue, and the leach is conducted under basic conditions.

19. The method claimed in claim 1, wherein the crushed ore is solid or agglomerated particles with a particle size less than 10 mm in size.

20. The method claimed in claim 19, wherein the crushed ore is solid or agglomerated particles with a particle size less than 5 mm in size.

21. The method claimed in claim 20, wherein the crushed ore is solid or agglomerated particles with a particle size less than 3 mm in size.

22. The method claimed in claim 21, wherein the crushed ore is solid or agglomerated particles with a particle size less than 1 mm in size.

23. The method claimed in claim 1, wherein the sealed heap has a height of between 5-50 m.

24. The method claimed in claim 23, wherein the sealed heap has a height of between 20-30 m.

25. The method claimed in claim 1, wherein the sealed heap is utilised to store residue at the completion of the heap leach.

26. The method claimed in claim 1, wherein the sealed heap heated using external heating.

27. The method claimed in claim 1, wherein the ore is an ultramafic ore which and the heap leach residue is utilised for subsequent sequestration of carbon dioxide.

28. The method claimed in claim 1, wherein the sealed heap is utilised to leach ores under climatic conditions in which it is difficult to maintain a water balance with rainfall or evaporation that occurs with an open heap.

29. The method claimed in claim 1, wherein the sealed heap is dynamic in nature, and utilises a fixed structure to contain the crushed ore, which is then removed from the structure when it has been leached, and replaced with another batch of ore.

30. The method claimed in claim 1, including multiple sealed heaps, with each heap comprising a cell.

31. The method claimed in claim 30, wherein reagents are transferred within and between cells within a heap or heaps to control leaching conditions, and to minimize reagent losses in the leach residue.

32. The method claimed in claim 30, wherein leachant is transferred within and between the cells to transfer heat between cells.

33. The claimed in claim 30, wherein gas is transferred within and between cells to control the oxygen content of the heap and optimise the efficient use of oxygen.

34. The method claimed in claim 30, wherein the leachant is transferred between cells to vary the irrigation rate of the heap, according to its extent of leaching.

35. The method claimed in claim 1, wherein the sealed heap is further insulated with a layer of sand on top of the impermeable coating.

36. The method claimed in claim 1, wherein flotation concentrate is mixed with the crushed rock and leached in the sealed heap to provide both additional heat and dissolve the contained values.

37. The method claimed in claim 1, wherein the leachant irrigation rate is adjusted according to the extent of leaching to rapidly recover values early in the leaching cycle, and then increase the tenor of the pregnant liquor late in the cycle.

38. The method claimed in claim 1, wherein the ore is ultramafic nickel ore and the leachant is ammonia.

39. A heap for recovering metal values from ore in a heap leach process, comprising:
crushed ore stacked on an impermeable pad to form a heap with a bottom and a top;
a substantially impermeable coating enclosing the heap;
an irrigation system for irrigating leachant inside at the top of the crushed ore heap;
a sump for removing leachant at the base of the heap; and
means for adding an oxygen enriched gas to the sealed heap.

40. The heap claimed in claim 39, wherein the ores contains one or more of the valuable metals of copper, gold, nickel, uranium and zinc.

41. The heap claimed in claim 39, wherein the crushed ore includes sulphide concentrates that have been mixed with the ore, and contain one or more of iron and the valuable metals of copper, gold, nickel, uranium and zinc.

42. The heap claimed in claim 39, wherein the ore is crushed ore that was at least partially agglomerated prior to stacking.

43. The heap claimed in claim 39, wherein the ore is crushed to less than 10 mm.

44. The heap claimed in claim 43, wherein the ore is crushed to less than 5 mm.

45. The heap claimed in claim 44, wherein the ore is crushed to less than 3 mm.

46. The heap claimed in claim 39, wherein the heap has a height of between 5 and 50 m.

47. The heap claimed in claim 46, wherein the heap has a height of between 20 and 30 m.

48. The heap claimed in claim 39, wherein the heap is dynamic in nature, and utilises a fixed structure to contain the crushed ore, which is then removed from the structure when it has been leached and is replaced in the reactor with another batch of ore.

49. A structure comprising multiple sealed heaps as defined in claim 39, with each heap comprising a cell.

50. The structure claimed in claim 49, including means for transferring reagents between cells to control leaching conditions.

51. The structure claimed in claim 49, including means for transferring leachant between the cells to transfer heat between cells.

52. The structure claimed in clam 49, including means for transferring gas between cells to control the oxygen content of the heap and optimise the efficient use of oxygen.

53. The heap or structure claimed in claim 39, wherein the heap or cells is/are further insulated with a layer of sand on top of the impermeable coating.
